(19) United States
(12) Patent Application Publication
(10) Pub. No.: US 2026/0019118 A1
(43) Pub. Date: Jan. 15, 2026

(54) POWER-SAVE MODES FOR CHANNEL STATE INFORMATION (CSI) GATHERING

(71) Applicant: Cypress Semiconductor Corporation, San Jose, CA (US)

(72) Inventors: Vikram Kumar Ramanna, San Jose, CA (US); Kiran Uln, Pleasanton, CA (US); Rakesh Taori, McKinney, TX (US); Kameswara Medapalli, Saratoga, CA (US)

(73) Assignee: Cypress Semiconductor Corporation, San Jose, CA (US)

(21) Appl. No.: 18/771,188

(22) Filed: Jul. 12, 2024

(51) Int. Cl. H04B 7/06; H04W 52/02

(52) U.S. Cl. CPC H04B 7/0626; H04W 52/0206

(57) ABSTRACT

A wireless device includes a front end and a processor coupled to the front end. The processor determines that a second wireless device within operative communication range of the front end is to transmit channel state information (CSI) packets at a predetermined schedule. The processor causes the wireless device to enter a power-save mode. The processor causes the wireless device to exit the power-save mode at a frequency based on the predetermined schedule of the second wireless device transmitting the CSI packets and causes the front end to intercept the CSI packets.

### TECHNICAL FIELD

This disclosure relates to wireless devices and, more specifically, to power-save modes for channel state information (CSI) gathering.

### BACKGROUND

Typical wireless Internet-of-Things (IoT) devices need to operate primarily at a low power, e.g., a power-save mode to conserve power related to wireless communication. This is at least because IoT devices have only intermittent needs to communicate wirelessly and to always be in a full-power and fully communicative mode would be to needlessly waste power. For some IoT devices, power conservation has a higher importance if the IoT devices are powered by a battery, solar cell, or some source of power other than an alternating-current (AC) power source.

### BRIEF DESCRIPTION OF THE DRAWINGS

FIG. 1 is a simplified block diagram of a wireless network in which an example IoT device operates in relation to other wireless devices according to various embodiments.

FIG. 2 is an operational diagram of exemplary receipt, by an IoT device, of both beacon frames containing CSI packets and other packets, according to some embodiments.

FIG. 3 is a flow chart of a method for managing exiting from a power-save mode to consume CSI packets transmitted at a predetermined schedule according to some embodiments.

FIG. 4A is a flow chart of a method for updating a refresh rate of gathering CSI packets based on a frequency of transmission of the CSI packets by another wireless device according to some embodiments.

FIG. 4B is a flow chart of a method for updating a refresh rate of gathering CSI packets based on negotiating a target wake time (TWT) schedule for another wireless device according to some embodiments.

FIG. 5 is an exemplary geographical layout of the wireless network in which interception of CSI packets can be limited by distance from the IoT device according to various embodiments.

FIG. 6 is a flow chart of a method for modifying gain of an IoT device based on distance to wireless devices from which the IoT device is configured to receive CSI packets according to some embodiments.

### DETAILED DESCRIPTION

The following description sets forth numerous specific details such as examples of specific systems, devices, components, methods, and so forth, in order to provide a good understanding of various embodiments of power-save modes for channel state information (CSI) gathering. For example, CSI packets can be gathered out of the air from numerous wireless devices and which contain CSI data that characterizes the properties of a wireless communication channel. These CSI-based properties, when characterized, can greatly influence the performance of a communication link between a transmitter and receiver, e.g., between a transmission wireless device and a reception wireless device.

In particular, CSI data captures path loss, or the reduction in power density of a signal as it propagates through space. Further, CSI data captures fading, or variations in the amplitude of a signal at a receiver due to changes in the transmission medium or path. Additionally, CSI data captures time delay, e.g., delays incurred by the signal as it travels through different paths from the transmitter to the receiver. Also, CSI data captures phase shift, or changes in the phase of the signal as it encounters different propagation environments. Thus, if CSI packets are gathered by a wireless device (such as an IoT device) from other wireless devices in the vicinity of the IoT device, the IoT device can determine, from the CSI data, how it should operate on a wireless channel to ensure connectivity and efficiency in wirelessly communicating in a particular wireless environment. As discussed previously, however, for an IoT device to operate continuously to capture these CSI packets would be to needlessly consume power.

To resolve deficiencies with known approaches to power conservation in IoT devices (or other low-power devices), according to disclosed embodiments, the present disclosure sets forth methods, generally to be implemented by an IoT device, in which the IoT device remains in a power-save mode and wakes up according to a determined schedule or based on triggers obtained from the other wireless devices to intercept CSI packets transmitted within operative communication range of the IoT device. The IoT device can then exit at the moment of (or just before) an expected transmission of a CSI packet in order to intercept that CSI packet out of the air and then go back to sleep, e.g., back into a power-save mode. Thus, as will be apparent, the wireless devices from which the CSI packets are intercepted need not be directly communicating with the IoT device.

Further, in addition to these methods, or as alternative methods, the present disclosure includes the IoT device determining a distance to a farthest wireless device from which the IoT device is configured to obtain CSI packets. The IoT device can then change (e.g., reduce), if possible, a gain element to change a power gain of its front end to intercept CSI packets from the farthest wireless device but not from wireless devices located beyond that distance. In this way, power consumption of the IoT device can be limited to no more than necessary to capture CSI packets from wireless devices for which it has been configured to obtain CSI. Further, interference and noise that may be passing through the environment beyond the distance is not captured by nor poses a problem for the IoT device.

In at least some embodiments, an IoT wireless device includes a front end and a processor coupled to the front end. In embodiments, the processor determines that a second wireless device within operative communication range of the front end is to transmit channel state information (CSI) packets at a predetermined schedule and/or periodically. The second wireless device can be a peer wireless device, another IoT device, or an anchor wireless device such as a hub or an access point device or the like. Further, the predetermined schedule or periodicity of the second wireless device transmitting the CSI packets can be associated with a refresh rate of the IoT device that is set according to different factors, such as a time of day (and thus how probable it is that an IoT motion sensor is going to need to be more active) or a target wake time (TWT) schedule of the second wireless device, as will be discussed in more detail. In embodiments, the refresh rate can be understood as how often in a given time period the IoT device wakes up to intercept and act on CSI packets.

In some embodiments, the processor causes the IoT wireless device to enter a power-save mode, e.g. as a normal mode of operation. The processor can then cause the IoT wireless device to exit the power-save mode at a frequency based on the predetermined schedule of the second wireless device transmitting the CSI packets and cause the front end to intercept the CSI packets. In embodiments, the processor can further, after each interception of a CSI packet from the second wireless device, cause the IoT wireless device to re-enter the power-save mode.

The present disclosure includes a number of advantages, including the ability for an IoT device to operate as configured to intercept CSI packets from the air and use data from those CSI packets to optimize operation on a channel, all while conserving power by being in a power-save mode the majority of the time, e.g., except when gathering the CSI packets from the air. The present disclosure also includes advantages based on the ability of the IoT device to reduce (or throttle) power element of its front end based on the distance to the farthest wireless device from which the IoT device is configured to gather such CSI packets. Additional advantages will be apparent to those skilled in the art of IoT-based wireless communication and are discussed further below.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment of the invention. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

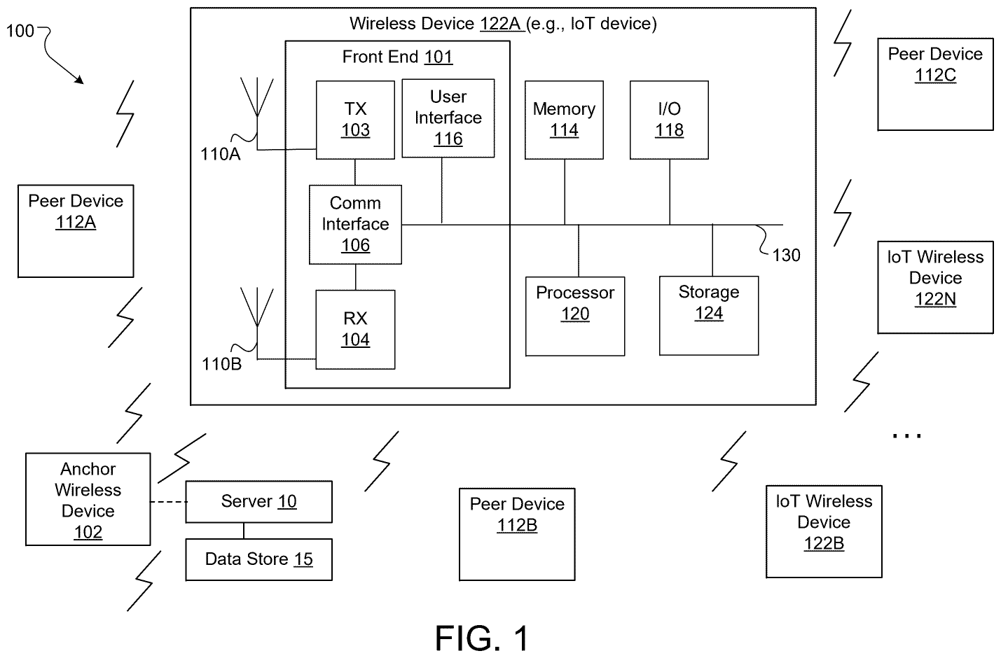

FIG. 1 is a simplified block diagram of a wireless network 100 in which an example IoT device 122A operates in relation to other wireless devices according to various embodiments. In embodiments, the other wireless devices include an anchor wireless device 102, one or more peer devices 112A-112B, and one or more additional IoT devices 122B . . . 122N, all of which may be understood to be possible wireless devices as described herein. In some embodiments, the anchor wireless device 102 is coupled (wired or wirelessly) to a server 10 (e.g., a cloud server), which is coupled to a data store 15 storing data and/or instructions. In embodiments, the anchor wireless device 102 is an access point (AP) device, a wireless router, a wireless mesh node, a wireless gateway, a cellular base station or tower, an IoT hub or gateway, or the like.

In various embodiments, the IoT devices discussed herein can be any low-power device that has limited operational capabilities of varying ranges based on how the IoT devices are powered and configured. While some IoT devices are AC-powered, the present disclosure is primarily focused on battery-powered wireless devices that seek to more-aggressively conserve (or reduce) power consumption. Thus, at least the IoT device 122A can be understood to be a motion sensor (or other type of wireless sensor), a microprocessor-based transmitter that provides limited data on behalf of an appliance or machine, a smartphone, or other wireless communication device that is powered by a battery, a solar cell, or the like.

In at least some embodiments, the IoT device 122A includes, but is not limited to, a front end 101 having a transmitter 103 or TX (e.g., a WLAN transmitter), a receiver 104 or RX (e.g., a WLAN receiver), a communications interface 106, and a user interface 116. The IoT device 122A may further include at least one TX antenna 110A coupled to the transmitter 103, and at least one RX antenna 110B coupled to the receiver 104. In some embodiments, at least the transmitter 103 and the receiver 104 form a transceiver of the IoT device 122A. In some embodiments, the front end 101 includes switching circuitry to switch between dual bands, including for example, between two of the 2.4 GHz, 5 GHZ, and 6 GHz bands, although many IoT devices operate over a single frequency channel.

The IoT device 122A may further include a memory 114, one or more input/output (I/O) devices 118 (such as a display screen, a touch screen, a keypad, and the like), a processor 120, and a storage device 124. These components can all be coupled to a communications bus 130 or multiple communication buses. In some embodiments, at least some of the components of the IoT device 122A are directly connected and may thus not be coupled through the communication bus 130. Thus, illustration of the communication bus 130 is not be taken as required or limiting for at least some of the components of the IoT device 122A, which may directly intercommunicate. In some embodiments, aspects of the communication interface 106 work with the processor 120 to perform operations or that function as a processing device of the IoT device 122A. In some embodiments, there is a single antenna and multiplexing logic to switch use of the antenna between the TX and RX.

In at least some embodiments, the memory 114 and/or the storage device 124 include computer storage to store instructions executable by the processor 120 and/or data generated or accessed by the communication interface 106 or generated by the processor 120. The processor 120 can use the storage device 124 during execution of program code, which can be stored in the memory 114 that may or may not be the same memory components, depending on application and implementation. In various embodiments, frontend components such as the transmitter 103, the receiver 104, the communication interface 106, and one or more antennas are adapted with or configured for WLAN and WLAN-based frequency bands, e.g., Wi-Fi®, Bluetooth® (BT), Bluetooth® Low Energy (LBE), Ultra-Wideband (UWB), Z-wave™, Zigbee®, LoRa™, Wi-SUN®, or other wireless protocol. While some of the wireless protocols may also be referred to as personal area network (PAN) technology, for simplicity, all are broadly referred to as WLAN technology. Future wireless protocols are also envisioned.

In various embodiments, the communication interface 106 coordinates, as directed by the processor 120, to request/receive packets from the other wireless devices or those that reflect off of objects. In embodiments, these are CSI packets such as those discussed herein. The communications interface 106 can further process data symbols received by the receiver 104 in a way that the processor 120 can perform further processing, including identifying and parsing data packets received within the wireless signals.

In various embodiments, the IoT device 122A intercepts CSI packets transmitted by the anchor wireless device 102, the one or more peer devices 112A-112B, and/or the one or more additional IoT devices 122B . . . 122N in the normal course of communication. Indeed, these CSI packets are likely not intended for the IoT device 122A, yet the IoT device 122A can determine a predetermined schedule, periodicity, or other timing by which these other wireless devices transmit their CSI packets. In some embodiments, the server 10 configures each wireless device with a list of the other wireless devices from which each respective wireless device is expected to obtain CSI packets.

In some embodiments, the IoT device 122A remains in power-save mode except for waking up to intercept CSI packets and to perform an intermittent function such as, for a motion sensor, sensing presence of different objects (such as humans) in an environment of the IoT device 122A, or for a temperature or pressure sensor, to intermittently measure an environment and provide sensed values (of temperature or pressure) to the server 10, for example. Different power-save modes are envisioned, including, but not limited to, a power-save mode (PS), a power save poll (PSPoll), a delivery traffic indication message (DTIM), an unscheduled automatic power save delivery (U-APSD), and a target wake time (TWT). The IoT device 122A may function in one or more of these power-save modes and optionally switch between these power-save modes at different times, depending on application, design, and available power.

In various embodiments, in the PS mode the IoT device 122A functions in one of an active mode or a power-save mode. The active mode of the IoT device 122A keeps its Wi-Fi® radio on at all times (ready to send and receive messages without delay) and the power-save mode in which the IoT device 122A signals to the anchor wireless device 102 that it is going to sleep and wakes up at predefined intervals to check for messages. The anchor wireless device 102 can buffer the data intended for the sleeping IoT device 122A. The PSPoll is mechanism where the IoT device 122A periodically “polls” the anchor wireless device 102 by sending a PS-Poll frame to request any data that the access point may have buffered while the device was asleep. The IoT device 122A can also operate in a DTIM mode in which devices that are asleep wake up at intervals defined by the DTIM period to receive broadcast or multicast messages that the anchor wireless device 102 buffers. The U-APSD mode may be used primarily in voice applications. For example, U-APSD allows the IoT device 122A to wake up and send a trigger frame to the anchor wireless device 102, which then sends any buffered data to the IoT device 122A. The IoT device 122A can go back to sleep after receiving the data without waiting for the next beacon. In some embodiments, in a TWT mode, the IoT device 122A negotiates specific times with the anchor wireless device 102 to wake up and communicate, significantly reducing power consumption by allowing devices to sleep for longer periods. Some of these power-save modes may not be compatible with the present embodiments of waking up to intercept CSI packets, e.g., may be more specific to waking up to receive data packets.

In some embodiments, the IoT device 122A intercepts a particular number of CSI packets or CSI packets for a particular time period, combines a feature list from the CSI packets, and analyzes the feature list for purposes of adjusting parameters of wireless communication, e.g., gain, phase shift, directionality of wireless signal, and the like. In other embodiments, the IoT device 122A transmits the combined feature list to the server 10, e.g., via the anchor wireless device 102. In such embodiments, the server 10 can instead perform the channel characteristic analysis and provide modifications in communication parameters transmitted back to the IoT device 122A. The IoT device 122A, in this way, need not perform significant processing to still benefit from and adjust its wireless communication according to intercepted and aggregated CSI packets. Continued reference to FIG. 1 will be made throughout the hereinbelow discussion.

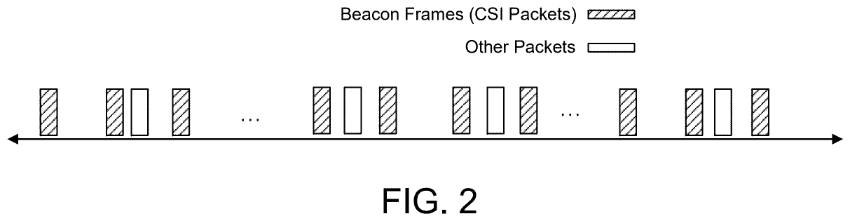

FIG. 2 is an operational diagram of exemplary receipt, by the IoT device 122A, of both beacon frames containing CSI packets and other packets, according to some embodiments. Because the CSI packets are transmitted by other wireless devices at a predetermined schedule or periodicity, the IoT device 122A can determine that predetermined schedule (or periodicity) and set a wake-up schedule out of power-save mode based on that predetermined schedule (or periodicity). In some embodiments, the predetermined schedule or periodicity changes based on a beacon frame transmission rate, e.g., where the CSI packets are (or are included in) beacon frames transmitted by a second wireless device. In some embodiments, the predetermined schedule or periodicity changes according to a TWT of a second wireless device.

The TWT mode of operation, which was previously mentioned, is a technology introduced as part of the IEEE 802.11ax standard, also known as Wi-Fi® 6. Thus, TWT is designed to significantly improve the power efficiency of Wi-Fi® devices. TWT allows wireless devices to negotiate specific times to access the air and transmit data, which means these wireless devices can stay in a low-power (sleep or a power-save) mode when not actively transmitting or receiving data. This is particularly beneficial for battery-powered devices like many IoT devices, helping to extend their battery life.

In various embodiments, in TWT mode, the IoT device 122A negotiates with the anchor wireless device 102 to establish specific times when the IoT device 122A will wake up to intercept CSI data as well as other times to send/receive data. Thus, this negotiation can include when the IoT device 122A will wake up (e.g., a frequency of waking up to refresh the IoT device 122A) to gather and process CSI packets transmitted by other wireless devices. In embodiments, once the schedule is established, the IoT device device can turn off its wireless radio (or the front end 101) and enter a low-power sleep (or power-save) mode during off times, waking up at the negotiated times in a particular sleep/wake cycles. During some wake times, the IoT device 122A can intercept CSI packets from other wireless devices. During other wake times, the IoT device can wake up to communicate with the anchor wireless device 102 to send and/or receive data.

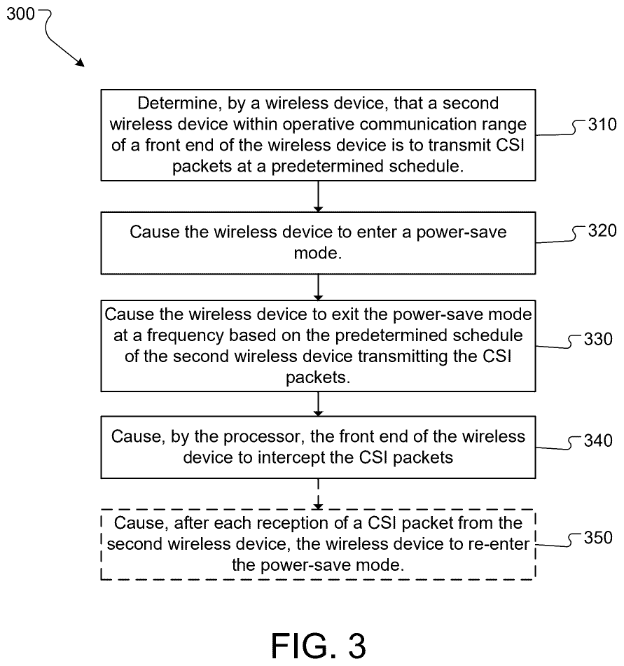

FIG. 3 is a flow chart of a method 300 for managing exiting from a power-save mode to consume CSI packets transmitted at a predetermined schedule according to some embodiments. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by a wireless device, e.g., processing logic of any IoT device illustrated or discussed herein.

At operation 310, the processing logic determines, by a processor of a wireless device, that a second wireless device within operative communication range of a front end of the wireless device is to transmit channel state information (CSI) packets at a predetermined schedule and/or periodically. In embodiments, the front end and processor are associated with an IoT wireless device.

At operation 320, the processing logic causes the wireless device to enter a power-save mode, such as one of the power-save modes discussed with reference to FIGS. 1-2.

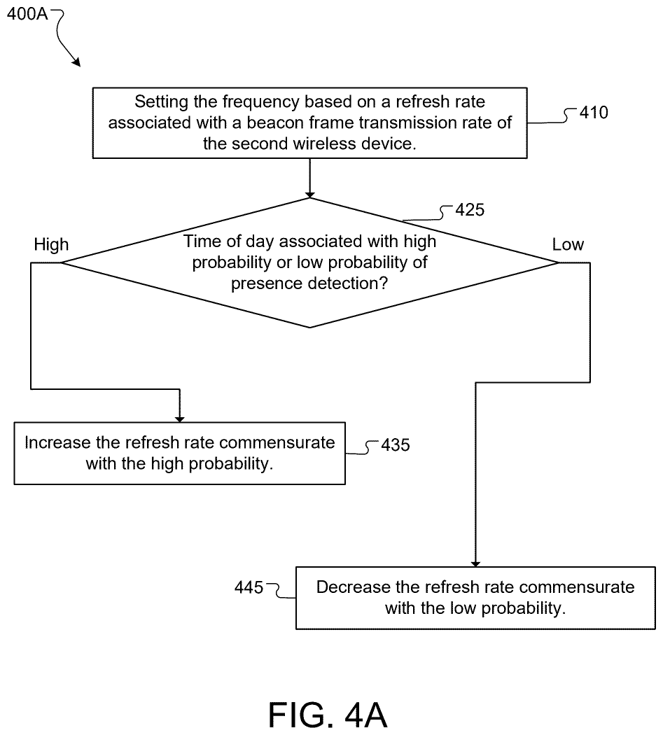

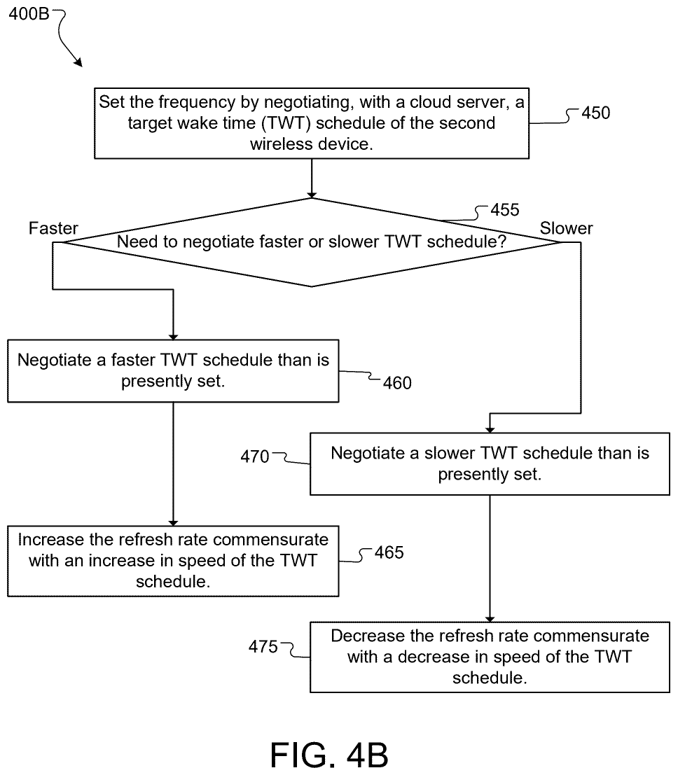

At operation 330, the processing logic causes the wireless device to exit the power-save mode at a frequency based on the predetermined schedule (or periodicity) of the second wireless device transmitting the CSI packets. Setting this frequency based on a changing periodicity of CSI transmission will be discussed in more detail with reference to FIGS. 4A-4B.

At operation 340, the processing logic causes the front end of the wireless device to intercept the CSI packets.

At operation 350, processing logic causes, after each interception of a CSI packet from the second wireless device, the wireless device to re-enter the power-save mode.

FIG. 4A is a flow chart of a method 400A for updating a refresh rate of gathering CSI packets based on a frequency of transmission the CSI packets by another wireless device according to some embodiments. The method 400A can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400A is performed by a wireless device, e.g., processing logic of any IoT device illustrated or discussed herein. In some embodiments, the IoT device 122A to which the method 400A relates is a motion sensor, and thus the front end 101 and the processor 120 are configured to detect a presence of moving objects such as a human.

At operation 410, the processing device sets the frequency (referred to at operation 330 of FIG. 3) based on a refresh rate associated with a beacon frame transmission rate of the second wireless device. In some embodiments, the second wireless device is any of the other wireless devices (besides the IoT device 122A) illustrated in FIG. 1.

At operation 425, the processing determines whether a time of day is associated with a high probability of presence detection or a low probability of presence detection, e.g., of target objections that move.

At operation 435, in response to determining, at operation 425, that a time of day is associated with a high probability of presence detection (e.g., during an afternoon or evening time of day) compared with other times of the day, the processing logic increases the refresh rate commensurate with the high probability. For example, a higher refresh rate may be a approximately 10 hertz (Hz) or greater.

At operation 445, in response to determining, at operation 445, that a time of day is associated with a low probability of presence detection (e.g., during the night or early morning) compared with other times of the day, the processing logic decreases the refresh rate commensurate with the low probability. For example, a lower refresh rate may be between approximately 0.1-1.0 Hz. Thus, a mid-refresh rate may be a default refresh rate of approximately 1.1-9.9 Hz during other times of day.

FIG. 4B is a flow chart of a method 400B for updating a refresh rate of gathering CSI packets based on negotiating a target wake time (TWT) schedule for another wireless device according to some embodiments. The method 400B can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 400B is performed by a wireless device, e.g., processing logic of any IoT device illustrated or discussed herein. In some embodiments, the IoT device 122A to which the method 400A relates is a motion sensor, and thus the front end 101 and the processor 120 are configured to detect a presence of moving objects such as a human.

At operation 450, the processing logic sets the frequency (referred to at operation 330 of FIG. 3) by negotiating, with a cloud server, a target wake time (TWT) schedule of the second wireless device. In embodiments, the cloud server is the server 10 and the second wireless device is the anchor wireless device 102 (e.g., an AP) of FIG. 1. In embodiments, the TWT schedule is associated with a refresh rate based on the periodicity of another wireless device transmitting the CSI packets, e.g., which is referred to as the second wireless device in this example.

At operation 455, the processing logic determines whether to negotiate a faster or a slower TWT schedule. As just two examples, the IoT device 122A can be an interactive IoT device that engages conversation with humans or be a motion sensor that detects human movement. In some embodiments, if the IoT device 122A detects the presence of a human, the IoT device 122A can need to negotiate a faster TWT schedule. Otherwise, during quiet times, the IoT device 122A can negotiate a slower TWT schedule. Thus, in some embodiments, a higher TWT schedule is associated with a higher refresh rate (e.g., which may be associated with a busier period of interactivity or motion) and a lower TWT schedule is associated with a lower refresh rate (e.g., which may be associated with a less busy period of interactivity or motion or a desire to lower power consumption).

At operation 460, the processing device, in response to needing a faster TWT schedule at operation 455, negotiates, with the cloud server, a faster TWT schedule than is presently set.

At operation 465, the processing device increases the refresh rate commensurate with an increase in speed of the TWT schedule.

At operation 470, the processing device, in response to needing a slower TWT schedule at operation 455, negotiates, with the cloud server, a slower TW schedule than is presently set.

At operation 475, the processing device decreases the refresh rate commensurate with a decrease in speed of the TWT schedule.

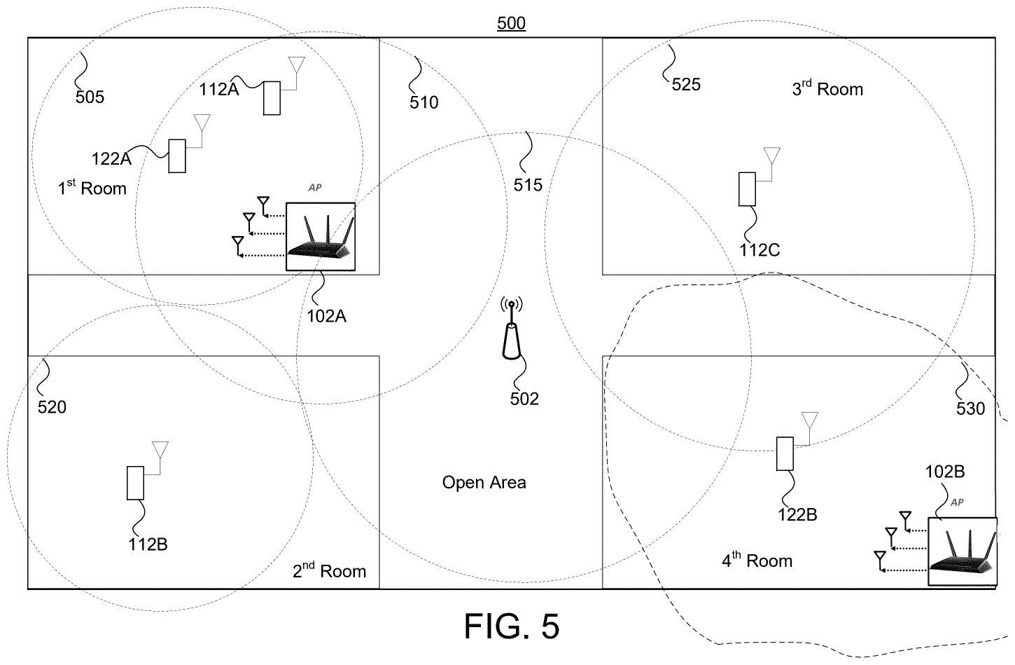

FIG. 5 is an exemplary geographical layout 500 of the wireless network 100 in which interception of CSI packets can be limited by distance from the IoT device 122A according to various embodiments. In some embodiments, there are two anchor wireless devices, a first anchor wireless device 102A located in a first room and a second anchor wireless device 102B located in a fourth room. In some embodiments, the IoT device 122A is located in the first room as well as a first peer device 112A. In embodiments, a second peer device 112B is located in a second room, a third peer device 112C is located in a third room, and a second IoT device 122B is located in the fourth room with the second anchor wireless device 102B. In embodiments, a wireless interference source 502 (which could represent smartphones moving around between the room) is located in an open area between the rooms.

In embodiments, the geographical layout 500 is exemplary only and to illustrate some overlapping wireless signals that result from various wireless devices having different gain levels that extend different distances. For example, the IoT device 122A can have a gain level of a distance 505, the first peer device 112 can have a gain level of a distance 510, the wireless interference source 502 can have a gain level of distance 515, the second peer device 112B can have a gain level of a distance 520, the third peer device 112C can have a gain level of distance 525, and the second IoT device 122B can have a gain level of distance 530. Note that signal radiation signatures due to gain level can overlap.

In some embodiments, the server 10 (FIG. 1) can transmit lists of wireless devices to configure each other wireless device in the geographical layer 500. Each list, for example, can be those wireless devices from which a respective individual wireless device is to obtain CSI packets. Thus, based on this list, it is possible that any given wireless device has a gain that is too large, e.g., can be reduced and still intercept CSI packets from a farthest wireless device included within the list of wireless devices. So, for example, assume that the IoT device 122A normally has a power gain corresponding to the distance 525, yet receives a list of wireless devices that includes only the first peer device 112A and the first anchor wireless device 102A. This scenario is realistic because the CSI packets of these two devices, which are co-located with the IoT device 122A in the first room, will have the most-relevant CSI data for the IoT device 122A. Thus, because the first anchor wireless device 102A is the wireless device in the CSI configuration list that is farthest from the IoT device 122A, the IoT device 122A can be configured to change a gain element to, e.g., reduce its power gain to correspond to the distance 505, which extends only to the first anchor wireless device 122A. In this way, the IoT device 122A can seek to intercept CSI packets approximately only within the first room and will not be influenced by CSI packets or interference present outside of the first room.

Thus, in some embodiments, the IoT device 122A determines, from a cloud server such as the server 10, that the second wireless device is within a particular distance of the IoT device 122A and that there is no farther wireless device with which the IoT device 122A is configured to wirelessly communicate. The IoT device 122A can then cause a gain element of the front end 101 to be changed (e.g., reduced power gain) to not attempt to intercept the CSI packets from wireless devices located outside of the particular distance. In this way, the IoT device 122A can cover the first room without trying to intercept CSI packets from other unrelated sources and/or from sources of interference that may cause the IoT device 122A to unnecessarily have to wake up and consume power that could otherwise be conserved. In some embodiments, a high-power gain such as may be associated with the distance 525 from the third peer device 112C could be between 60 and 80 decibels (dB) while a low-power gain associated with the distance 505 to the IoT device 122A could be between 20-40 db.

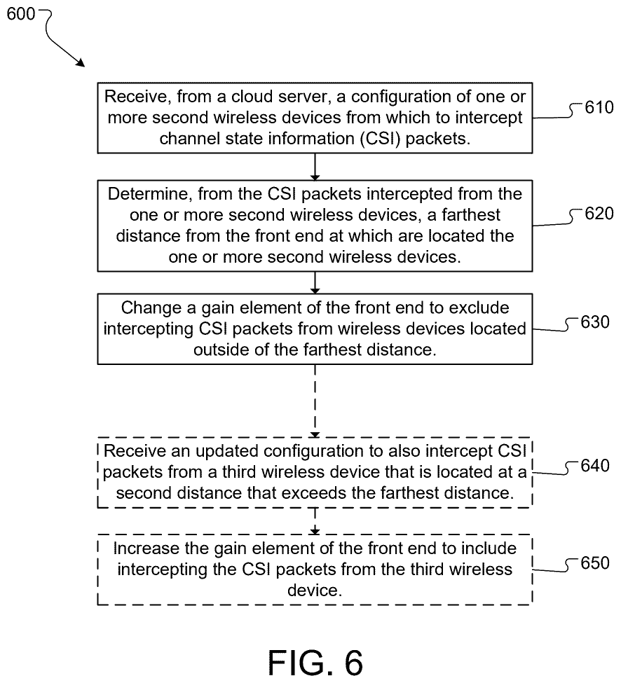

FIG. 6 is a flow chart of a method 600 for modifying gain of an IoT device based on distance to wireless devices from which the IoT device is configured to receive CSI packets according to some embodiments. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by a wireless device, e.g., processing logic of any IoT device illustrated or discussed herein.

At operation 610, the processing logic receives, from a cloud server, a configuration of one or more second wireless devices from which to intercept channel state information (CSI) packets.

At operation 620, the processing logic determines, from the CSI packets intercepted from the one or more second wireless devices, a farthest distance from the front end at which are located the one or more second wireless devices.

At operation 630, the processing logic changes a gain element of the front end to exclude intercepting CSI packets from wireless devices located outside of the farthest distance. In some embodiments, changing the gain element includes reducing the power of the gain element.

At operation 640, the processing logic optionally receives an updated configuration to also intercept CSI packets from a third wireless device that is located at a second distance that exceeds the farthest distance.

At operation 650, the processing logic, in response to receiving the update configuration, increases the gain element of the front end to include intercepting the CSI packets from the third wireless device.

In various embodiments, the IoT device 122A can take additional measures to save power, e.g., by ensuring efficient operation and power transmission. For example, the IoT device 122A could also choose the correct data rate and Tx power level to power-efficiently upload compressed feature set of CSI to the server 10. Further, the IoT device 122A could use the acknowledgement (ACK) to transmitted packets to revalidate the presence of objects, e.g., thus providing a faster refresh rate for presence detection when the IoT device 122A is awake. For example, the IoT device 122 could also measure the channel also during transmitting the ACK packet.

It will be apparent to one skilled in the art that at least some embodiments may be practiced without these specific details. In other instances, well-known components, elements, or methods are not described in detail or are presented in a simple block diagram format in order to avoid unnecessarily obscuring the subject matter described herein. Thus, the specific details set forth hereinafter are merely exemplary. Particular implementations may vary from these exemplary details and still be contemplated to be within the spirit and scope of the present embodiments.

Reference in the description to “an embodiment,” “one embodiment,” “an example embodiment,” “some embodiments,” and “various embodiments” means that a particular feature, structure, step, operation, or characteristic described in connection with the embodiment(s) is included in at least one embodiment. Further, the appearances of the phrases “an embodiment,” “one embodiment,” “an example embodiment,” “some embodiments,” and “various embodiments” in various places in the description do not necessarily all refer to the same embodiment(s).

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

The description includes references to the accompanying drawings, which form a part of the detailed description. The drawings show illustrations in accordance with exemplary embodiments. These embodiments, which may also be referred to herein as “examples,” are described in enough detail to enable those skilled in the art to practice the embodiments of the claimed subject matter described herein. The embodiments may be combined, other embodiments may be utilized, or structural, logical, and electrical changes may be made without departing from the scope and spirit of the claimed subject matter. It should be understood that the embodiments described herein are not intended to limit the scope of the subject matter but rather to enable one skilled in the art to practice, make, and/or use the subject matter.

Certain embodiments may be implemented by firmware instructions stored on a non-transitory computer-readable medium, e.g., such as volatile memory and/or non-volatile memory. These instructions may be used to program and/or configure one or more devices that include processors (e.g., CPUs) or equivalents thereof (e.g., such as processing cores, processing engines, microcontrollers, and the like), so that when executed by the processor(s) or the equivalents thereof, the instructions cause the device(s) to perform the described operations for USB-C/PD mode-transition architecture described herein. The non-transitory computer-readable storage medium may include, but is not limited to, electromagnetic storage medium, read-only memory (ROM), random-access memory (RAM), erasable programmable memory (e.g., EPROM and EEPROM), flash memory, or another now-known or later-developed non-transitory type of medium that is suitable for storing information.

Although the operations of the circuit(s) and block(s) herein are shown and described in a particular order, in some embodiments the order of the operations of each circuit/block may be altered so that certain operations may be performed in an inverse order or so that certain operation may be performed, at least in part, concurrently and/or in parallel with other operations. In other embodiments, instructions or sub-operations of distinct operations may be performed in an intermittent and/or alternating manner.

In the foregoing specification, the disclosure has been described with reference to specific exemplary embodiments thereof. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense.

What is claimed is:

1. A wireless device comprising:
a front end; and
a processor coupled to the front end, wherein the processor is to:
determine that a second wireless device within operative communication range of the front end is to transmit channel state information (CSI) packets at a predetermined schedule;
cause the wireless device to enter a power-save mode;
cause the wireless device to exit the power-save mode at a frequency based on the predetermined schedule of the second wireless device transmitting the CSI packets; and
cause the front end to intercept the CSI packets.

2. The wireless device of claim 1, wherein the front end and processor are associated with an internet-of-things (IoT) wireless device.

3. The wireless device of claim 1, wherein the processor is further to cause, after each interception of a CSI packet from the second wireless device, the wireless device to re-enter the power-save mode.

4. The wireless device of claim 1, wherein the processor is further to set the frequency based on a refresh rate associated with a beacon frame transmission rate of the second wireless device.

5. The wireless device of claim 4, wherein the front end and processor are configured to detect a presence of moving objects, and wherein the processor is further to:
determine a time of day is associated with a high probability of presence detection compared with other times of the day; and
increase the refresh rate commensurate with the high probability.

6. The wireless device of claim 4, wherein the front end and processor are configured to detect a presence of moving objects, and wherein the processor is further to:
determine a time of day is associated with a low probability of presence detection compared with other times of the day; and
decrease the refresh rate commensurate with the low probability.

7. The wireless device of claim 1, wherein the processor is further to set the frequency by negotiating, with a cloud server, a target wake time (TWT) schedule of the second wireless device, wherein the TWT schedule is associated with a refresh rate based on the predetermined schedule.

8. The wireless device of claim 7, wherein the processor is further to:
negotiate, with the cloud server, a faster TWT schedule than is presently set; and
increase the refresh rate commensurate with an increase in speed of the TWT schedule.

9. The wireless device of claim 7, wherein the processor is further to:
negotiate, with the cloud server, a slower TWT schedule than is presently set; and
decrease the refresh rate commensurate with a decrease in speed of the TWT schedule.

10. The wireless device of claim 1, wherein the processor is further to:
determine, from a cloud server, that the second wireless device is within a particular distance of the wireless device and that there is no farther wireless device with which the wireless device is configured to wirelessly communicate; and
cause a gain element of the front end to be changed to not attempt to intercept the CSI packets from wireless devices located outside of the particular distance.

11. A wireless device comprising:
a front end; and
a processor coupled to the front end, wherein the processor is to:
receive, from a cloud server, a configuration of one or more second wireless devices from which to intercept channel state information (CSI) packets;
determine, from the CSI packets intercepted from the one or more second wireless devices, a farthest distance from the front end at which are located the one or more second wireless devices; and
reduce a gain element of the front end to exclude intercepting CSI packets from wireless devices located outside of the farthest distance.

12. The wireless device of claim 11, wherein the processor is further to:
receive an updated configuration to also intercept CSI packets from a third wireless device that is located at a second distance that exceeds the farthest distance; and
increase the gain element of the front end to include intercepting the CSI packets from the third wireless device.

13. A method comprising:
determining, by a processor of a wireless device, that a second wireless device within operative communication range of a front end of the wireless device is to transmit channel state information (CSI) packets at a predetermined schedule;
causing, by the processor, the wireless device to enter a power-save mode;
causing the wireless device to exit the power-save mode at a frequency based on a predetermined schedule of the second wireless device transmitting the CSI packets; and
causing, by the processor, the front end of the wireless device to intercept the CSI packets.

14. The method of claim 13, further comprising causing, after each interception of a CSI packet from the second wireless device, the wireless device to re-enter the power-save mode.

15. The method of claim 13, further comprising setting the frequency based on a refresh rate associated with a beacon frame transmission rate of the second wireless device.

16. The method of claim 15, further comprising:
determining a time of day is associated with a high probability of presence detection compared with other times of the day; and
increasing the refresh rate commensurate with the high probability.

17. The method of claim 15, further comprising:
determining a time of day is associated with a low probability of presence detection compared with other times of the day; and
decreasing the refresh rate commensurate with the low probability.

18. The method of claim 13, further comprising setting the frequency by negotiating, with a cloud server, a target wake time (TWT) schedule of the second wireless device, wherein the TWT schedule is associated with a refresh rate based on the predetermined schedule.

19. The method of claim 18, further comprising:
negotiating, with the cloud server, a faster TWT schedule than is presently set; and
increasing the refresh rate commensurate with an increase in speed of the TWT schedule.

20. The method of claim 18, further comprising:
negotiating, with the cloud server, a slower TWT schedule than is presently set; and
decreasing the refresh rate commensurate with a decrease in speed of the TWT schedule.

21. The method of claim 13, further comprising:
determining, from a cloud server, that the second wireless device is within a particular distance of the wireless device and that there is no farther wireless device with which the wireless device is configured to wirelessly communicate; and
causing a gain element of the front end to be reduced to not attempt to intercept the CSI packets from wireless devices located outside of the particular distance.
